(19) United States
(12) Patent Application Publication
(10) Pub. No.: US 2007/0138295 A1
(43) Pub. Date: Jun. 21, 2007

(54) Method for authenticating an item

(76) Inventor: Daniel F. White, Gainesville, GA (US)

Correspondence Address: Christopher P. Ricci;Intellectual Property Section, Law Department, NCR Corporation, 1700 South Patterson Blvd., Dayton, OH, 45479-0001, US

(21) Appl. No.: 11/314,697

(22) Filed: Dec. 21, 2005

(51) Int. Cl. G06K 19/06; G06K 7/00

(52) U.S. Cl. 235/491; 235/435

(57) ABSTRACT

A method for verifying authenticity of an item is provided. The method comprises forming a medium containing one or more tags having a first physical or chemical state and a second physical or chemical state corresponding to an inactive condition and an activated condition, respectively. One or more tags are changed from an inactive condition to an activated condition at a point of origin upon issuance of an item formed from the medium, to provide a distinctive security label for subsequent verification of authenticity of the item.

### TECHNICAL FIELD

The subject matter described herein relates to a method for authenticating an item that contains one or more security tags that can be activated at a point of origination.

### BACKGROUND

There is an increasing need to provide methods for securing and authenticating documents and goods. Security markers such as watermarks, fluorescent inks, security threads, holograms, are known approaches to verify authenticity of an object, such as a bank note or other document, a retail good, a gift card, etc. Existing security markers enable a person, such as a retail clerk, business owner, or bank officer, a method for verifying that the item is authentic. For example, a business owner can inspect a document or a good under ultraviolet light for the presence or absence of a fluorescent ink. Or a bank officer can inspect a note for the presence or absence of a hologram.

These and other known security markers provide an acceptable approach for determining that a particular document, medium, card, good, or the like, is formed on or from an authentic medium. For example, presence of a watermark on a security note evidences that the note was prepared from a medium bearing the distinctive water mark. Presence of a particular security thread on a receipt issued by a store that prints receipts on paper with that particular security thread evidences that the receipt is printed on that particular paper.

A shortcoming of these security approaches is that it is not possible to verify that the item itself is authentic, but only permits verification that the medium on which the item was formed was authentic. For example, in the example above, a retailer inspecting the receipt can look for the particular security thread, but cannot determine whether the actual receipt itself is authentic. If the receipt paper had been stolen or duplicated without authorization, an inspection solely for the security thread would not reveal whether the receipt was not authentic but had been printed on stolen or duplicated paper with the same security thread and was, thus, a fake receipt.

Thus, there remains a need in the art for a method for verifying the authenticity of an item that is prepared on-a medium having a security marker.

The foregoing examples of the related art and limitations related therewith are intended to be illustrative and not exclusive. Other limitations of the related art will become apparent to those of skill in the art upon a reading of the specification and a study of the drawings.

### SUMMARY

The following aspects and embodiments thereof described and illustrated below are meant to be exemplary and illustrative, not limiting in scope.

In one aspect, a method for verifying authenticity of an item is provided. The method comprises forming a medium containing one or more tags having a first physical or chemical state and a second physical or chemical state corresponding to an inactive condition and an activated condition, respectively. One or more tags are changed from an inactive condition to an activated condition at a point of origin upon issuance of an item based on the medium, to provide a distinctive security label for subsequent verification of authenticity of the item.

In one embodiment, the change from the first physical or chemical state to the second physical or chemical state is achieved by contacting all or a portion of the medium with an activator selected from the group consisting of ultraviolet light, a chemical, and thermal energy.

In another embodiment, the one or more tags are comprised of a carrier and a rare-earth element combination, where the rare earth element is incorporated in and interacts with the carrier to provide an emission profile.

In another embodiment, the change from the first physical or chemical state to the second physical or chemical state in one or more of the tags is achieved by applying thermal energy to the medium. For example, a thermal activator that applies a specific temperature for a minimum specified period of time is contemplated. In another embodiment, a thermal activator that applies a first thermal energy at a first temperature followed by a second thermal energy at a second temperature is contemplated.

In another embodiment, change from the first physical or chemical state to the second physical or chemical state is achieved by a chemical compound contacted with the medium, wherein the chemical compound interacts with all or a part of the one or more tags to provide the distinctive security label.

In yet another embodiment, a change from the first physical or chemical state to the second physical or chemical state is achieved by exposing the medium to a photon source. For example, the photon in the source can be infrared rays, visible light, ultraviolet rays, or X-rays.

In another embodiment, the method further comprises contacting the medium with an activator to form the distinctive security label and inspecting the distinctive security label to verify authenticity of the medium. Inspection of the label can be, for example, by a human eye or by a machine.

The medium, in various embodiments, can be a paper medium, such as a paper document, or a polymeric medium, such as a plastic card. In another embodiment, the medium is a laminate.

In another aspect, a system for subsequent verification of authenticity is provided. The system is comprised of a medium containing one or more tags capable of activation for detection by transition from a first physical or chemical state to a second physical or chemical state; and an activator for activating at least a portion of the one or more tags to provide a distinctive security label on all or a portion of the medium.

In addition to the exemplary aspects and embodiments described above, further aspects and embodiments will become apparent by reference to the drawings and by study of the following descriptions.

### DETAILED DESCRIPTION

There are innumerable items which are subject to theft, counterfeiting, or forgery and for which authentication or verification are necessary or desired. For example, in some situations the following exemplary documents or media may benefit from a method to verify authenticity: financial documents, such as banknotes, traveler's checks, checks, currency, credit cards, bank cards, stock certificates, and bearer bonds; identification credentials, such as identification cards, passports, visas, licenses, and immigration documents; tickets, receipts, and certificates. Additionally, a wide variety of products and manufactured goods, such as but not limited to computer parts, software packaging, and pharmaceutical packaging, would benefit from a method to verify authenticity.

Accordingly, a method for verifying authenticity of an item or a medium, such as the exemplary items and media noted in the preceding paragraph, is provided. In the method, a medium that contains one or more tags is formed. The one or more tags have a first physical or chemical state and a second chemical or physical state, the first and second states corresponding to an inactive and an activated condition, as will be further described below. When all or a portion of the one or more tags in the medium are caused to be changed into an activated condition at a point of origin upon issuance of an item formed with the medium, a distinctive security label is formed that can be relied upon for subsequent verification of authenticity of the item.

The tags, also referred to herein as security tags or taggants, can be prepared from a wide variety of materials, and specific examples are given below. It can be appreciated that the claimed method does not rely on the material from which the tags are formed, provided the tags are formed from one or more materials that alone or in combination can be caused to change from a first physical or chemical state to a second physical or chemical state. A change in physical states can be evidenced by, for example, a change of phase, such as melting or boiling, or a change in shape, such as embossed paper. A physical change of a material does not usually create a new material, but the material retains its same chemical composition. A physical change is also typified by a conservation of mass, where the mass of the material, under ideal conditions, in its first and second states is the same.

A change from a first to a second chemical state typically results in the creating of one or more new compounds. The material undergoes a chemical change with atoms or ions regrouping. Chemical changes are often evidenced by, for example, a change in color, a change in texture, or a change in form. Chemical changes can be caused by application of thermal energy (heat) to a material or by mixing or contacting a material with a chemical.

The tag is induced to transition from a first physical or chemical state to a second physical or chemical state by an activator. The activator, selected based on the material from which the tags are formed, serves to induce the change in physical or chemical state, i.e., to change the tags from an inactive to activated condition. Several exemplary activators include thermal energy, pressure, a photon source, a chemical compound, a combination of one or more chemical compounds, and a combination of two or more different activators. A thermal energy activator can take the form of a heat source, such as a heated printing head or a hand-held heating tip. An activator in the form of a photon source intends a source that produces photons, where one photon corresponds to the smallest amount of electromagnetic radiation that can exist, irrespective of wavelength, frequency, energy, or momentum. The photon source can provide photons of any wavelength in the electromagnetic spectrum, but will commonly be a source that produces photons in the infrared, visible, ultraviolet, or X-ray regions of the spectrum. Chemical activators can be organic or inorganic compounds from any source, synthetic or natural.

Tags can be coated onto all or a portion of a medium or can be embedded into all or a portion of a medium during fabrication of the medium. For example, polymer microcapsules entrapping a dye, ink, or other marker, can be coated or applied onto the surface of a medium from a solvent. Alternatively, such microcapsules can be admixed with the components used to form the medium. By way of another example, paper with thermochromic ink can be prepared, with one or more layers of ink embedded into the paper. Yet another example is application of a paper document having an invisible ink coated onto all or certain regions of the document. It will be appreciated that a medium can comprise one or more tags on or in all or a portion of the medium.

In one embodiment, a unique tag is made for the exclusive use of a particular good, object, medium, company, or individual. In an alternative or additional embodiment, a unique activator is provided for the exclusive use by a particular entity, for example such as a company, a particular store at a certain location of a parent company, or an individual. For example, a retail store or banking institution would issue a document or other item to a customer, wherein the item has a taggant that uniquely identifies that institution. An example of taggants that can provide a unique fingerprint are rare earth element incorporated into a carrier, as described in U.S. Publication Nos. 2004/026547 and 2005/0143249, which are incorporated by reference herein. The rare earth elements are exemplified by the lanthanides, corresponding to atomic numbers 58 to 71 of the periodic table. The rare earth element has an intrinsic set of energy levels that yields a unique fluorescence profile. When incorporated into a carrier, such as a glass or polymer bead, the interaction between the carrier and the rare earth element changes the intrinsic profile of the element to create a specific fluorescence “fingerprint” of the element and the carrier.

To illustrate the method, several examples of media containing one or more taggants and items issued from such media are set forth below. It will be appreciated that the examples are intended to illustrate the method and in no way limit the described method.

In a first example, a method for verifying the authenticity of a store receipt is described. A paper medium containing a thermally activated ink is prepared. More specifically, paper having one or more layers of color, such as cyan, magenta, and yellow, is prepared according to known procedures. The paper and a printer with a print head capable of heating the paper to a selected temperature are provided to the store. When a customer purchases a good from the store, a receipt of the transaction is printed on the paper. The printer is programmed to heat to a certain preselected temperature and to contact the paper at a certain place for a particular period of time. Contact with the heated print head induces the ink taggants embedded in the paper to change from a first invisible condition to a second visible condition, so that on a portion of the receipt a distinctive label is placed. The distinctive label corresponds to a unique identification for the store and can optionally be in a particularized pattern as a secondary indicia of identity. The temperature and time profile is specific to the paper and required to induce a chemical change in the ink from invisible to visible, corresponding to an inactive and an activated condition. It will be appreciated that various temperature and time profiles can be used, where one or more temperatures held for one or more periods of time are required to induce the chemical change in the taggant. The receipt issued to the customer by the store thus includes a distinct security label. In this way, if a customer enters the store to return a good allegedly purchased at the store the receipt proffered by the customer can be inspected by the store clerk for the presence or absence of the security label. Presence of the label is indicative of an authentic receipt issued by the store. Absence of the label or the presence of an incorrect label is indicative of a forged receipt.

In a second example, a method for verifying authenticity of a ticket will be described. The ticket can be a ticket for entrance to a scheduled event, such as an airplane departure, a sporting event, a concert, or the like. The event vendor, which can, for example, be an airline company or an event organizer, is supplied with a medium on which the ticket is to be printed or is preprinted. Printed on the surface of each ticket in a selected region is, for example, the name of the event vendor. The ink used to print the name is a color-changing ink that changes from a first chemical state to a second chemical state in the presence of a selected chemical or combination of chemicals. For example, the ink can contain water as a solvent, ethylene glycol as a humectant, a nonsudsing detergent, citric acid to maintain a low pH, and a dye of a particular color. An activating “pen” that includes a chemical activator comprised of a reducing agent, such as sodium sulfite, and/or a base, such as sodium hydroxide, is also supplied to the event vendor. Upon issuance of a ticket to a purchaser, the event vendor activates the ink taggants by applying with the activator pen the reducing agent and/or base to that portion of the ticket containing the ink taggants. Application of the activator causes a change in color of the ink taggants, resulting in a security label unique to that event vendor. The ticket purchaser upon attending the event presents the ticket for entrance, and authenticity of the ticket can be verified by inspecting the ticket for the presence or absence of the unique security label.

By way of a third example, a method for verifying authenticity of a gift card is described. A retail store is provided with plastic media for use as gift cards. Embedded in all or a portion of each gift card is a taggant comprised of a rare earth element incorporated into a polymer carrier. The polymer is selected to be opaque prior to exposure to UV light. Upon exposure to UV light, a crosslinking reaction is initiated, causing a physical change in the polymer and transition from a first chemical state to a second chemical state, where the polymer becomes or approaches transparency. When a gift card is issued by the retail store to a bona fide customer, the card is exposed to a UV light activator to induce the polymer carrier in the tags to undergo a crosslinking reaction. The spectral signature of the tags after UV exposure is different from the spectral signature before UV exposure, providing a unique security label on the gift card. When a customer enters the store to purchase goods and presents a gift card for payment, the retail clerk can verify authenticity of the card as being issued from the store, i.e., the point of issuance and authorization, by inspecting for the unique spectral signature using a suitable optical scanner or other instrument.

In a fourth example, a method to verify authenticity of a financial or legal document is described. A financial institution is provided with certificate documents prepared from a laminate medium comprised of a cloth-reinforced paper. Each document has a surface treatment on all or a portion of the document that applies a first chemical taggant to the document. The institution is also provided with a stamp that has a unique identifier and with a stamp pad containing a second chemical. The second chemical is reactive with the first chemical to induce a chemical change in the first chemical taggant, the change being visible upon inspection by a human or a machine. Upon issuance of a document to a client, the stamp is pressed onto the pad to transfer second chemical to the stamp. The stamp is then contacted with the document in the region where the first chemical taggant resides to apply the second chemical to the taggants. Application of the second chemical to the document results in a distinctive security label being formed on the document at the time of issuance and at its point of origin. At a later time, authenticity of the document can be confirmed by inspection of the security label, the presence of which proves issuance of the document by the institution.

Based on the foregoing examples, it can be appreciated that another aspect of the invention includes a system for use in practicing the method. The system is comprised of a medium containing one or more tags in combination with an activator for inducing the tags to undergo a physical or chemical change is provided. The change “activates” the tags and provides a distinctive security label comprised of one or more of the tags. The medium containing the tag(s) can be, for example, a paper with a taggant embedded in the paper or applied to the outer surface of the paper. The medium can also be a polymer medium with the tags embedded in the polymer matrix or with the tags coated on all or a portion of the polymer medium. The activator is selected for interaction with the tags and is designed and packaged for use by, preferably, a human.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

It is claimed:

1. A method for verifying authenticity of an item, comprising
forming a medium containing one or more tags having a first physical or chemical state and a second physical or chemical state corresponding to an inactive condition and an activated condition, respectively, wherein said one or more tags are changed from an inactive condition to an activated condition at a point of origin upon issuance of an item prepared from the medium, to provide a distinctive security label for subsequent verification of authenticity of the item.

2. The method of claim 1, wherein change from the first physical or chemical state to the second physical or chemical state is achieved by contacting all or a portion of the medium with an activator selected from the group consisting of ultraviolet light, a chemical, and thermal energy.

3. The method of claim 1, wherein said one or more tags are comprised of a carrier and a rare-earth element combination, where the rare earth element is incorporated in and interacts with the carrier to provide an emission profile.

4. The method of claim 1, wherein change from the first physical or chemical state to the second physical or chemical state is achieved by applying thermal energy to said medium.

5. The method of claim 4, wherein change from the first physical or chemical state to the second physical or chemical state is achieved by a thermal activator that applies a specific temperature for a minimum specified period of time.

6. The method of claim 4, wherein said thermal activator applies a first thermal energy at a first temperature followed by a second thermal energy at a second temperature.

7. The method of claim 1, wherein change from the first physical or chemical state to the second physical or chemical state is achieved by a chemical compound contacted with the medium, wherein said chemical compound interacts with said one or more tags provide the distinctive security label.

8. The method of claim 1, wherein change from the first physical or chemical state to the second physical or chemical state is achieved by exposing the medium to a photon source.

9. The method of claim 8, wherein said photon is selected from the group consisting of infrared rays, visible light, ultraviolet rays, and X-rays.

10. The method of claim 1, further comprising contacting said medium with an activator to form the distinctive security label and subsequently inspecting said distinctive security label to verify authenticity of the item.

11. The method of claim 10, wherein said inspecting comprises detection by a human eye or by a machine.

12. The method of claim 1, wherein said medium is a paper or polymeric medium.

13. The method of claim 12, wherein said medium is a paper document.

14. The method of claim 12, wherein said medium is a plastic card.

15. The method of claim 12, wherein said medium is a laminate.

16. A system for validating a medium for subsequent verification of authenticity, comprising:
a medium containing one or more tags capable of activation for detection by transition from a first physical or chemical state to a second physical or chemical state;
an activator for activating at least a portion of the one or more tags to provide a distinctive security label on all or a portion of the medium.

17. The system of claim 16, wherein said activator is selected from the group consisting of a photon source, a chemical, and thermal energy.

18. The system of claim 17, wherein said activator is a photon source comprises a photon selected from the group consisting of infrared rays, visible light, ultraviolet rays, and X rays.

19. The system of claim 17, wherein said activator is thermal energy at a selected temperature for a selected period of time.

20. The system of claim 17, wherein said activator is thermal energy comprised of a first temperature for a selected period of time and a second temperature for a selected period of time.

21. The system of claim 16, wherein said medium is a paper or polymeric medium.

22. The system of claim 16, wherein said medium is a paper document.

23. The system of claim 16, wherein said medium is a plastic card.

24. The system of claim 16, wherein said medium is a laminate.
